(19) United States
(12) Patent Application Publication
(10) Pub. No.: US 2026/0008297 A1
(43) Pub. Date: Jan. 8, 2026

(54) ARTIFICIAL ROCK AND METHOD OF MANUFACTURE

(71) Applicant: Sergiu Gabriel Mihu, Newtown, CT (US)

(72) Inventor: Sergiu Gabriel Mihu, Newtown, CT (US)

(21) Appl. No.: 18/766,588

(22) Filed: Jul. 8, 2024

(51) Int. Cl. B44F 9/04; C04B 26/06; C04B 103/54

(52) U.S. Cl. CPC B44F 9/04; C04B 26/06; C04B 2103/54

(57) ABSTRACT

The disclosed technology relates to an artificial rock formation designed to resemble natural sand, coral, and sediment reef rock, composed of bonded aggregate mix particles. The aggregate mix consists of sand, crushed coral, crushed seashells, rock fragments, or a combination thereof, which are bonded together into larger shapes using a bonding agent, while maintaining a visible granular structure. The resulting formation exhibits a free-form or naturally irregular surface, determined in general by the spray pattern and by the fact that some particles are not fully encapsulated by the bonding agent. The artificial rock does not require large structural components for stability and retains the natural appearance of its constituent materials without visibly encapsulating a bonding layer. The final product may be used for aquariums, decorative applications, ensuring a realistic texture and structure suitable for various ecological and ornamental uses.

### CROSS-REFERENCE TO RELATED PATENT APPLICATION(S)

The present application claims the benefit of the earlier filing date of U.S. Provisional Application No. 63/512,612, filed Jul. 8, 2023, the disclosure of which is hereby incorporated by reference in its entirety.

### PRIOR ART

Artificial rocks have been created through various patented methods over time, using resins, concrete, sand, plastics, through shaping or the use of molds.

U.S. Pat. No. 20060147656A1 (2006), to Mathieu proposes a method of producing an artistic replica of natural coral reef rock. The process is limited to a method of forming a slurry of cement or concrete using a mold.

U.S. Pat. No. 3,836,619A (1974), to Volent presents a method for creating artificial stone through a series of sprays, concluding with a transparent layer where sand is applied while the coating remains tacky. However, this method is constrained to using a fixed structure and applying sand over an uncured bonding agent. While a sandy texture can be achieved, the method fails to capture the diverse variations obtained by spraying or dripping the bonding agent over sand.

U.S. Pat. No. 4,385,088A (1983), to Baskin discloses an improved foamed synthetic plastic artificial rock. The invention involves a specialized epoxy coating filled with hard sand-like particles. However, the manufacturing process of applying epoxy coatings presents challenges, including prolonged solidification time and the complexity of effectively mixing the epoxy with sand-like particles.

### BACKGROUND

The invention relates to a method, and the resulting product, for creating artificial rock, rock structures, or similar decorative objects that possess the granular appearance of natural sand without requiring pre-shaped molds or large structural elements.

Current manufacturing methods typically involve using slurries or aggregate mixes that are either hand-shaped or cast into molds to produce rock-resembling objects. Another common technique involves spraying the surface of an existing structure with a bonding agent and then spreading sand or other aggregate particulates over it. In this process, some of the sand adheres to the surface, giving it a granular appearance. However, these methods often require multiple steps and prolonged curing times, leading to increased production complexity, higher costs, and potential environmental impact.

From a visual perspective, the limitations of using a mold in the process are evident in the repetitive and uniform appearance of the final product, lacking natural variation.

The use of bonding agents such as cement requires the final product to be submerged in water for a period of time to leach out harmful chemicals. Once the curing period is over and most of the chemicals have leached out, the objects become safe for use in contact with plants or animals, in use cases such as aquariums or flowerpots. However, the curing process releases chemicals into the environment, contributing to potential ecological concerns.

Another limitation of spreading aggregate mix over a sprayed bonding agent is the difficulty in achieving uniform and secure adhesion, as this method typically bonds a thin surface layer of the aggregate. As a result, multiple applications are often required to create a more natural and visually appealing texture.

Some methods use a fast-curing bonding agent; however, this approach limits the working time available for applying the aggregate mix, requiring precise timing and rapid handling. The result is usually a lower proportion of aggregate that successfully adheres to the surface, reducing the overall effectiveness and consistency of the process. These limitations are well-known drawbacks of current technologies.

The application of the method results in a unique structure formed from an aggregate mix of particles, creating a rock-like formation that visually and structurally mimics natural sedimentary deposits rather than traditional artificial rock formations. Unlike conventional artificial rocks that often rely on large aggregate pieces, pre-shaped molds, or external coatings to simulate texture, the disclosed invention produces a self-supporting matrix of smaller particulates fused together, achieving a visually natural, non-uniform composition.

The resulting artificial rock lacks any visible bonding agent, as the particles appear to be naturally fused together rather than adhered through an external coating. Unlike existing products where a visible film, glue, or hardened slurry encapsulates the material, this process ensures that the final rock retains the uncoated, natural granular appearance of the aggregate mix. This structure avoids the appearance of synthetic uniformity and instead allows for a dynamic and variable texture resembling coral rock, limestone, or naturally weathered sedimentary structures.

Another key advantage is that the artificial rock formation does not rely on large rock fragments or bulky aggregates for structural stability. Instead, the structure is formed entirely from a mix of smaller particulates that are bonded together, creating a solid and cohesive mass without the need for pre-shaped supports or external reinforcements. This composition allows for greater flexibility in shaping natural-looking formations, enabling the creation of intricate and irregular structures that resemble naturally occurring reef rock or sedimentary deposits. While the bonding agent secures the particulates together, the final structure retains the granular appearance of the aggregate mix, ensuring a more natural aesthetic compared to conventional molded or coated artificial rocks.

Due to the lack of visible binding materials, the artificial rock formation presents an organic appearance from all angles, without the signs of traditional bonding techniques such as layered coatings, abrupt material transitions, or unnatural surface finishes. This results in a more realistic alternative to traditional artificial reef rock, making it ideal for applications where aesthetics and biological compatibility are paramount.

### SUMMARY OF THE INVENTION

These and other problems can be addressed by embodiments of the technology disclosed herein. The disclosed technology describes an artificial rock formation composed of a bonded aggregate mix, designed to resemble the natural granular appearance of sand, coral rock, and sedimentary structures.

The aggregate mix consists of particulates such as sand, crushed coral, crushed seashells, gypsum, or a combination thereof, which contribute to the final structural integrity and aesthetic appeal. The proportion of these materials can vary, influencing the strength, texture, and color of the resulting rock.

The artificial rock can be shaped prior to the application of the bonding agent, and formed in various configurations to create continuous surfaces, domes, ridges, or free-standing structures. Unlike traditional molded artificial rocks, this invention enables greater variability in shape and texture, allowing for a natural and irregular aesthetic without the uniform appearance of molded structures.

A bonding agent is applied to secure the particulates into a stable structure. The bonding agent ensures that the rock retains its granular appearance without the visible coatings or surface layering seen in conventional artificial rock production. The application process allows the structure to form naturally without requiring large aggregate pieces for support.

This methodology supports the creation of highly variable and visually organic rock formations, including continuous textured surfaces or branch-like elements. Additionally, the bonding agent can be tinted or can have certain degrees of opacity to enhance the final appearance and better mimic natural rock formations.

A key advantage of this invention is its efficiency in production, as the bonding process eliminates the need for extended curing times associated with materials like concrete. This results in a more streamlined and scalable manufacturing process.

Another advantage of this methodology is the biological support it offers. The particles are not fully covered by the bonding agent, leaving a natural porous surface. The surface porosity and the internal porosity can lead to increased habitat area for microorganisms, maximizing the environment for beneficial bacteria to grow and live, promoting biodiversity. In the case of aquarium use, the resulting shapes can create a very unique habitat, with many hiding places for inhabitants, similar to a natural habitat.

These and other aspects of the present disclosure are described in the Detailed Description below and the accompanying figures. Other aspects and features of the present disclosure will become apparent to those of ordinary skill in the art upon reviewing the following description of the specific examples of the present disclosure in concert with the figures. While features of the present disclosure may be discussed relative to certain examples and figures, all examples of the present disclosure can include one or more of the features discussed herein. Further, while one or more examples may be discussed as having certain advantageous features, one or more of such features may also be used with the various other examples of the disclosure discussed herein. In similar fashion, while examples may be discussed below as devices, systems, methods or products, it is to be understood that such examples can be implemented in various devices, systems, methods or products of the present disclosure.

### BRIEF DESCRIPTIONS OF DRAWINGS AND FIGURES

The invention might be better understood by reference to one of the accompanying drawings below, in which:

FIG. 1 represents an overall view of the process.

FIG. 2 represents an overall representation of a sample particulates pile, resting on a surface, together with a continuous spray pattern.

FIG. 3 represents a possible result, combination of particulates and solidified adhesive.

FIG. 4 represents two possible particulate sizes.

### DETAILED DESCRIPTION OF THE INVENTION

The terminology used herein is for the purpose of describing the particular embodiments only and is not intended to be limiting of the invention. As used herein, the term “and/or” includes any and all combinations of one or more of the associated listed items. As used herein, the singular forms “a”, “an”, and “the” are intended to include the plural forms as well as the singular forms, unless the context clearly indicates otherwise. It will be further understood that the terms “comprises” and/or “comprising”, when used in this specification, specify the presence of stated features, steps, operations, elements, and/or components, but do not preclude the presence or addition of one or more other features, steps, operations, elements, components, and/or groups thereof.

The disclosed technology will be described more fully hereinafter with reference to the accompanying drawings. This disclosed technology can, however, be embodied in many different forms and should not be construed as limited to the examples set forth herein. The components described hereinafter as making up various elements of the disclosed technology are intended to be illustrative and not restrictive. Many suitable components that would perform the same or similar functions as components described herein are intended to be embraced within the scope of the disclosed technology. Component not described herein can include, but are not limited to, for example, components developed after development of the disclosed technology.

In the following description, numerous specific details are set forth. However, it is to be understood that examples of the disclosed technology can be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described can include a particular feature, structure, or characteristic, but not every embodiment necessarily includes the particular feature, structure, or characteristic. Further, repeated use of the phrase “in one embodiment” does not necessarily refer to the same embodiment, although it can.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Unless otherwise specified, the use of the ordinal adjectives “first,” “second,” “third,” etc., to describe a common object, merely indicate that different instances of like objects are being referred to and are not intended to imply that the objects so described should be in a given sequence, either temporally, spatially, in ranking, or in any other manner.

For purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

Examples of the disclosed technology are discussed herein with reference to “aggregate mix”, which may be composed of marine sand, crushed coral, crushed seashells, rocks, crushed rocks, or a combination thereof. The invention is not limited to these specific material, as other suitable particulates may be used to achieve the desired structural and visual characteristics. In addition, examples of the disclosed technology are discussed in reference to a “bonding agent” which may include “cyanoacrylate” or other adhesive compounds capable of solidifying the aggregate mix. Thus, while some embodiments may be described in relation to using sand, crushed seashells, and cyanoacrylate specifically, all examples of the disclosed technology can be used with particulates other than sand or crushed seashells, and bonding agents other than cyanoacrylate.

The present invention will now be described by referencing the appended figures representing preferred embodiments of the disclosed artificial rock formation.

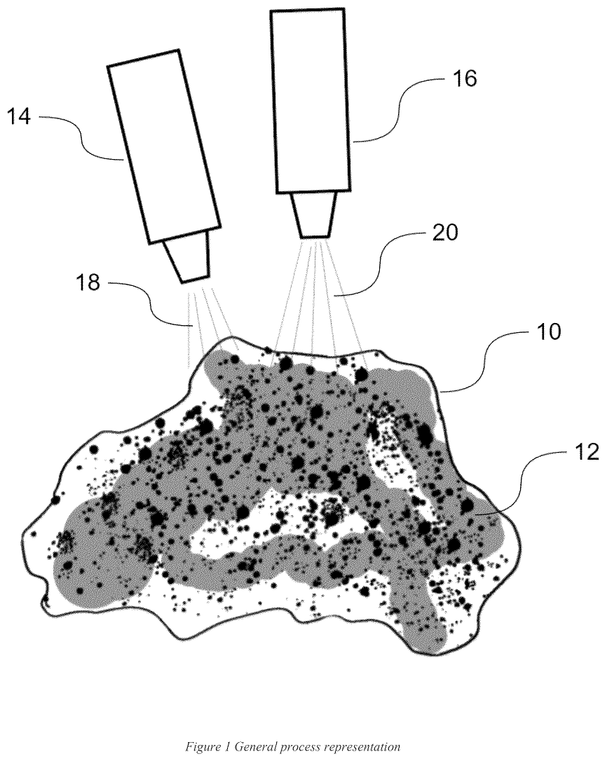

FIG. 1 illustrates a general diagram of the process. The aggregate mix 10 is a combination of various sized particles. The bonding agent fluid 18 is applied using a dispenser 14, and it may be applied over the particulates of the aggregate mix 10. The image illustrates a possible application area 12 for the bonding agent 18. The bonding agent fluid dispense path can be random, predefined, as a contiguous surface, as an interrupted surface, or as a combination thereof. The bonding agent can be activated by a different fluid called activator, dispensed from the dispenser 20. The activator fluid can be dispensed through the nozzle of the dispenser 16, partially or fully over the bonding fluid dispensing area 12.

The dispensing pattern of the bonding agent fluid 18 or the activator fluid 20 can be in the shape of spray or mist, drops, continuous flow, or a combination thereof, to achieve structural cohesion while preserving the natural texture of the aggregate mix. The process allows flexibility in shape formation, ensuring a non-uniform, organic final structure.

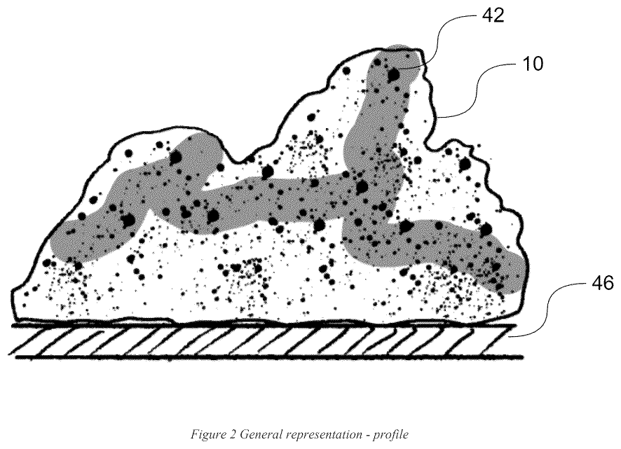

FIG. 2 illustrates a profile view of the aggregate mix particulates 10, showing how particulates can be arranged, into a pile, or structured over a working surface 46 before the bonding agent is applied. In this case the bonding agent fluid has been dispensed over-following the path 42.

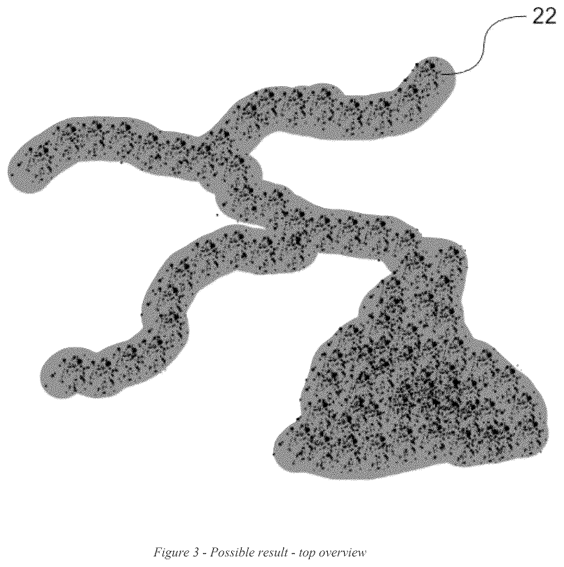

FIG. 3 shows a possible final artificial rock formation 22, constructed from bonded aggregate particulates 10. The structure retains the visible granular composition of the aggregate mix, with no prominent bonding agent layer obscuring its surface. This results in a naturally fused appearance, distinguishing it from traditional molded or coated artificial rocks.

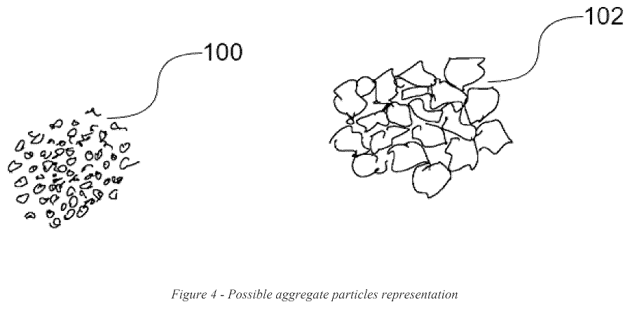

FIG. 4 illustrates two possible representations of the aggregate mix particulates, 100 and 102, of two different sizes. The particulates may be composed as a mix of various mesh sizes, typically ranging between mesh 3.5 and mesh 30, or between 5600 and 483 microns. Larger particles may also be incorporated, including but not limited to pebbles, crushed coral, crushed seashells, or seashells.

What is claimed is:

1. A method of manufacturing artificial rock formations comprising:
preparing an aggregate mix of particulates,
depositing the aggregate mix on the work surface,
dispensing the bonding agent over the aggregate mix,
removing the formation of bonded aggregate mix from the work surface, as artificial rock.

2. The method described in claim 1, wherein the aggregate mix is composed of sand, crushed coral, seashells, crushed seashells, or a combination thereof.

4. The method described in claim 1, wherein the aggregate mix is formed in a temporary shape on the work surface.

10. The method described in claim 1, wherein the bonding agent is cyanoacrylate, or a cyanoacrylate compound.

11. The method described in claim 1, wherein multiple bonding agents are used to achieve different structural or aesthetic effects.

12. The method described in claim 1, wherein the bonding agent is dispensed as a spray, as droplets, as a continuous stream, or a combination thereof.

13. The method described in claim 1, wherein the bonding agent is dispensed over a contiguous surface.

14. The method described in claim 1, wherein the bonding agent is dispensed over a noncontiguous surface.

16. The method described in claim 1, wherein the bonding agent is dispensed on the same path, random paths, or a combination thereof.

17. The method described in claim 1, wherein the bonding agent is tinted with a coloring agent.

19. The method described in claim 1, wherein the bonding agent is applied in a pattern that results in an uneven and varied final texture.

20. The method described in claim 1, wherein the bonding agent is applied to create a self-supporting structure without other elements for stability.

21. An artificial rock formation comprising:
an aggregate mix of particulates selected from sand, crushed coral, crushed seashells, rock fragments, or a combination thereof,
a solidified bonding agent securing the aggregate mix while maintaining a visible granular structure,
a self-supporting structure, free of large rock fragments for stabilization, a surface texture resembling natural sedimentary or coral rock formations.

22. The artificial rock formation described in claim 21, wherein the bonding agent is not visibly apparent on the final surface, allowing the aggregate mix to retain its natural, uncoated appearance.

23. The artificial rock formation described in claim 21, wherein the final structure includes branch-like formations, ridges, or continuous surfaces, providing a realistic rock-like appearance.

24. The artificial rock formation described in claim 21, wherein the bonded structure contains no more than 10% by volume of particulates larger than 5 mm.

25. The artificial rock formation described in claim 21, wherein the aggregate mix has a particle size distribution between 3.5 mesh and 30 mesh (5600 to 483 microns).

26. The artificial rock formation described in claim 21, wherein at least 50% by volume of the final structure is composed of bonded aggregate mix produced through this method.

27. The artificial rock formation described in claim 21, wherein the rock formation has at least one dimension greater than 25 mm and is incorporated as a bonded or structural component within another artificial or natural rock formation or assembly.

28. The artificial rock formation described in claim 21, wherein the rock formation has at least one dimension greater than 12 mm.
